(19) United States
(12) Patent Application Publication
(10) Pub. No.: US 2005/0036669 A1
(43) Pub. Date: Feb. 17, 2005

(54) Method, apparatus, and program for detecting abnormal patterns

(75) Inventors: Hideya Takeo, Kanagawa-ken (JP); Akio Ofuji, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILMS CO., LTD.

(21) Appl. No.: 10/897,397

(22) Filed: Jul. 23, 2004

(30) Foreign Application Priority Data
Jul. 25, 2003 (JP) (PAT.)279895/2003

(51) Int. Cl. G06K 9/00

(52) U.S. Cl. 382/128; 382/181

(57) ABSTRACT

Microcalcification patterns within images are more accurately detected. A candidate point extracting means extracts candidate points for calcification points from an image. A first removal means performs judgment regarding whether the candidate points are calcification points or noise, based on first characteristic amounts that focus on the calcification points themselves, and based on second characteristic amounts that focus on the vicinities of calcification points. Candidate points which are judged to be noise components are removed. A second removal means performs judgment regarding whether the candidate points, which remain after the removal process by the first removal means, are calcification points or noise, based on third characteristic amounts that focus on cluster regions of calcification points. Cluster regions formed of noise components are removed, and a detecting means 240 detects the remaining cluster regions as microcalcification patterns.

### BACKGROUND OF THE INVENTION

1. Field of the Invention

The present invention relates to a method, apparatus, and program for detecting abnormal patterns. Particularly, the present invention relates to a method, apparatus, and program for detecting microcalcifications within an image, based on image data that represents the image.

2. Description of the Related Art

There have been proposed abnormal pattern detection processing systems (computer assisted image diagnosis apparatuses) in the medical field (as disclosed in, for example, U.S. Pat. No. 5,761,334). These systems automatically detect abnormal patterns within images represented by image data, by use of computers.

These abnormal pattern detection processing systems automatically detect abnormal patterns by employing computers, based on characteristic density distributions and characteristic shapes of the abnormal patterns. Abnormal patterns are detected mainly by utilizing iris filter processes, which are suited for detecting tumor patterns, or by utilizing morphology filter processes, which are suited for detecting microcalcification patterns.

However, if detection is performed by simply utilizing the aforementioned processes, there are many cases in which noise components and portions of tissue, having density distributions and shapes that are similar to those characteristic of abnormal patterns, are erroneously detected. Therefore, methods in which discrimination processes are performed, to remove erroneously detected patterns from among detected abnormal patterns, have also been proposed.

Particularly regarding the detection of microcalcification patterns, there are discrimination processes based on characteristic amounts of the calcification points in microcalcification patterns. There are three known discrimination processes, each focusing on the properties of different characteristic amounts, that is, different regions of calcification points. The three discrimination processes are listed below.
(1) A discrimination process that focuses on characteristic amounts of individual calcification points (disclosed in, for example, Japanese Unexamined Patent Publication No. 2003-079604)
(2) A discrimination process that focuses on characteristic amounts of regions in the vicinities of individual calcification points (disclosed in, for example, U.S. Patent Laid-Open No. 20020196967)
(3) A discrimination process that focuses on characteristic amounts of microcalcification clusters (calcification point clusters), which are individual calcification points that are grouped into clusters (disclosed in, for example, R. Nakayama, Y. Uchiyama, I. Hatsukade et al., “Computerized Discrimination of Malignant and Benign Microcalcification Clusters on Mammograms”, Japanese Radiology Association Magazine, March 2000, pp 391-397; and T. Umeda, N. Shinohara, T. Hara et al., “Discrimination of Clustered Microcalcifications on Mammograms”, Gifu University Applied Engineering Information Department/Nagoya Hospital Radiology Department/Aichi Prefecture Oncology Center Hospital Breast Surgery Department, 1999, pp 89-93)

During actual diagnosis of microcalcification patterns by a physician, microcalcification patterns are discriminated by judging the characteristics according to the three regions as a whole.

In order to perform more accurate discrimination, combining the aforementioned three discrimination processes may be considered. However, the discriminating abilities greatly differ depending on the manner in which the processes are combined. Therefore, it is not possible to accurately discriminate microcalcification patterns by simply combining the discrimination processes.

### SUMMARY OF THE INVENTION

The present invention has been developed in view of the circumstances described above. It is an object of the present invention to provide a method, an apparatus, and a program for detecting abnormal patterns, which is capable of discriminating microcalcification patterns with high accuracy.

The first method for detecting abnormal patterns of the present invention comprises the steps of:

extracting candidate points for microcalcification patterns within an image, based on image data that represents the image;

judging whether the extracted candidate points are calcification points, based on first characteristic amounts that focus on calcification points of microcalcification patterns;

removing candidate points which are judged to not be calcifications in a first removal process;

judging whether the candidate points that remain after the first removal process are calcification points, based on second characteristic amounts that focus on the region in the vicinity of calcification points;

removing candidate points which are judged to not be calcification points in a second removal process;

judging whether the candidate points that remain after the second removal process are calcification points, based on third characteristic amounts that focus on cluster regions, formed of clusters of calcification points;

removing cluster regions which are judged not to be microcalcification patterns; and

detecting the remaining cluster regions as microcalcification patterns.

The first apparatus for detecting abnormal patterns of the present invention comprises:

candidate point extracting means, for extracting candidate points for microcalcification patterns within an image, based on image data that represents the image;

a first removal means, for judging whether the extracted candidate points are calcification points, based on first characteristic amounts that focus on calcification points of microcalcification patterns, and removing candidate points which are judged to not be calcifications in a first removal process;

a second removal means, for judging whether the candidate points that remain after the first removal process are calcification points, based on second characteristic amounts that focus on the region in the vicinity of calcification points, and removing candidate points which are judged to not be calcification points in a second removal process;

a third removal means, for judging whether the candidate points that remain after the second removal process are calcification points, based on third characteristic amounts that focus on cluster regions, formed of clusters of calcification points, and removing cluster regions which are judged not to be microcalcification patterns in a third removal process; and

a detecting means, for detecting the cluster regions that remain after the third removal process as microcalcification patterns.

The second method for detecting abnormal patterns of the present invention comprises the steps of:

extracting candidate points for microcalcification patterns within an image, based on image data that represents the image;

judging whether the extracted candidate points are calcification points, based on first characteristic amounts that focus on calcification points of microcalcification patterns and on second characteristic amounts that focus on the region in the vicinity of calcification points;

removing candidate points which are judged to not be calcification points;

judging whether the remaining candidate points are calcification points, based on third characteristic amounts that focus on cluster regions, formed of clusters of calcification points;

removing cluster regions which are judged not to be microcalcification patterns; and

detecting the remaining cluster regions as microcalcification patterns.

The second apparatus for detecting abnormal patterns of the present invention comprises:

a candidate point extracting means, for extracting candidate points for microcalcification patterns within an image, based on image data that represents the image;

a first removal means, for judging whether the extracted candidate points are calcification points, based on first characteristic amounts that focus on calcification points of microcalcification patterns and on second characteristic amounts that focus on the region in the vicinity of calcification points, and removing candidate points which are judged to not be calcification points in a first removal process;

a second removal means, for judging whether the candidate points that remain after the first removal process are calcification points, based on third characteristic amounts that focus on cluster regions, formed of clusters of calcification points, and removing cluster regions which are judged not to be microcalcification patterns in a second removal process; and

detecting means, for detecting the cluster regions that remain after the second removal process as microcalcification patterns.

The methods and apparatuses of the present invention perform a plurality of discrimination processes that focus on different regions of the candidate points, which had conventionally been performed separately or in inefficient combinations and orders, in combinations and orders that are empirically recognized to be effective.

The “first characteristic amounts that focus on calcification points” are values that quantitatively represent characteristics of the calcification points themselves. These characteristic amounts serve as bases for judgment regarding whether candidate points are actually calcification points.

The aforementioned “first characteristic amounts” may be at least one of characteristic amounts that represent the size, the density, and the shape of the candidate points.

As the “characteristic amounts that represent the size . . . of the candidate points”, the number of pixels occupied by the candidate points within the image may be considered. As the “characteristic amounts that represent the . . . density . . . of the candidate points”, the density values of the pixels within the image that correspond to the candidate points may be considered. As the “characteristic amounts that represent the . . . shape of the candidate points”, the degrees of circularity of the candidate points may be considered.

The “second characteristic amounts that focus on the region in the vicinity of calcification points” are values that quantitatively represent characteristics regarding the state of the regions in the vicinity of the calcification points. These characteristic amounts serve as bases for judgment regarding whether candidate points are actually calcification points.

The aforementioned “second characteristic amounts” may be at least one of characteristic amounts that represent the fluctuation in sizes, the fluctuation in densities, the fluctuation in shapes of the candidate points, and the number of candidate points which are present within a region of a predetermined size in the vicinity of a candidate point, weighted by one of the aforementioned fluctuations. The “region of a predetermined size” may be, for example, a circular region having a radius of 57 pixels, in the case that the image data is 10 bit, 10 mm/pixel data. However, the size and shape are not limited to these.

The “third characteristic amounts that focus on cluster regions” are values that quantitatively represent characteristics regarding the state within cluster regions, which are formed by grouping calcification points into clusters. These characteristic amounts serve as bases for judgment regarding whether candidate point clusters are actually calcification point clusters.

The aforementioned “third characteristic amounts” may be at least one of:

the number of candidate points within the cluster region, weighted corresponding to at least one of the number, the fluctuation in sizes, the fluctuation in densities, and the fluctuation in shapes of the candidate points;

the percentage of the number of candidate points within the cluster region with respect to the total number of the candidate points within the image; and

the percentage of the number of candidate points within the cluster region with respect to the total number of the candidate points within the image, weighted corresponding to at least one of the aforementioned fluctuations.

The “fluctuation in sizes . . . of the candidate points”, may be the variance of the number of pixels occupied by each candidate point within the region in the vicinity of the candidate points, or within the cluster region. The “fluctuation in densities . . . of the candidate points” may be the variance in the density values of pixels corresponding to each of the candidate points within the region in the vicinity thereof, or within the cluster region. The “fluctuation in shapes of the candidate points” may be the variance in the degree of circularity of the candidate points within the region in the vicinity thereof, or within the cluster region.

The “the number of candidate points within the cluster region, weighted corresponding to at least one of the . . . aforementioned fluctuations” may be a value, which is the number of candidate points multiplied by a coefficient that increases as the variance in sizes or densities increases. The probability that the candidate points are calcification points increases as the variance in the sizes or densities increases. The probability that the candidate points are noise components increases as the variance in the sizes or densities decreases. Therefore, a predetermined threshold value may be set, and if the aforementioned value is greater than or equal to the threshold value, the candidate points may be judged to be calcification points. If the aforementioned value is less than the threshold value, the candidate points may be judged to be noise components.

The judgment made by the first removal means of the first apparatus for detecting abnormal patterns of the present invention may be based on Mahalanobis distances from calcification patterns, which are calculated by the first characteristic amounts, and from noise components.

The judgment made by the first removal means of the second apparatus for detecting abnormal patterns of the present invention may be based on Mahalanobis distances from calcification patterns, which are calculated by the first characteristic amounts and the second characteristic amounts, and from noise components.

Here, the “Mahalanobis distances” are a measure of distance, which is employed to recognize patterns within an image. Similarities in image patterns may be discerned from the Mahalanobis distances. To perform judgment using Mahalanobis distances, first, a plurality of characteristics of image patterns are represented by vectors. The Mahalanobis distance is defined so as to reflect differences in the vectors between an image, which is the target of pattern recognition, and a reference image. Accordingly, whether the candidate points are calcification points may be judged, by discerning the similarities between the extracted candidate points and image patterns of malignant calcification points.

A Mahalanobis distance ratio is expressed as D2/D1, wherein D1 is a Mahalanobis distance to the candidate points from a pattern class which is empirically known to represent calcification points, and D2 is a Mahalanobis distance to the candidate points from a pattern class which is known to represent noise components. The probability that the candidate points are calcification points increases as the ratio increases, and the probability that the candidate points are noise components increases as the ratio decreases. Therefore, a predetermined value maybe set as a threshold value, and if the ratio is greater than or equal to the threshold value, the candidate points may be judged to be calcification points, and if the ratio is less than the threshold value, the candidate points may be judged to be noise components.

As the “candidate point extracting means”, that which utilizes a morphology filter may be considered. The morphology filter employs structural elements of a predetermined size, to remove or extract noise or patterns, which are smaller than the structural elements, from an image. Candidate points of microcalcification patterns, which are characteristics of breast cancer, can be extracted by utilizing a morphology filter that employs structural elements which are greater in size than microcalcification patterns (individual calcification point patterns) to be detected. The output values of morphology filter calculation processes are compared against predetermined threshold values, to extract the candidate points. For details regarding the morphology filter process, refer to the aforementioned U.S. Pat. No. 5,761,334.

The programs of the present invention are those that cause a computer to function as each of the means of the first and second apparatuses for detecting abnormal patterns of the present invention.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to; source, object and executable code, and can be in any language, including higher level languages, assembly language, and machine language.

According to the first method and apparatus for detecting abnormal patterns, discrimination processes are performed in an order which has been empirically proven to increase the accuracy of discrimination. First, a discrimination process is performed with respect to the extracted candidate points based on the first characteristic amounts, which focus on the calcification points of the microcalcification patterns themselves. Then, a discrimination process is performed based on the second characteristic amounts, which focus on the region in the vicinity of the calcification points. Next, a discrimination process is performed based on the third characteristic amounts, which focus on cluster regions formed of clusters of calcification points. Therefore, noise components are effectively removed, and it becomes possible to discriminate microcalcification patterns with high accuracy. Thereby, the diagnostic ability by a physician is improved.

According to the second method and apparatus for detecting abnormal patterns, the discrimination processes are performed in another order which has been empirically proven to increase the accuracy of discrimination. First, a discrimination process is performed with respect to the extracted candidate points based on the first characteristic amounts, which focus on the calcification points of the microcalcification patterns themselves, and based on the second characteristic amounts, which focus on the region in the vicinity of the calcification points. Next, a discrimination process is performed based on the third characteristic amounts, which focus on cluster regions formed of clusters of calcification points. Therefore, noise components are effectively removed, and it becomes possible to discriminate microcalcification patterns with high accuracy. Thereby, the diagnostic ability by a physician is improved.

### BRIEF DESCRIPTION OF THE DRAWINGS

FIG. 1 is a schematic diagram illustrating an apparatus 100 for detecting abnormal patterns, which is an embodiment of the first apparatus for detecting abnormal patterns of the present invention.

FIG. 2 is a flow chart that illustrates the processes performed by the apparatus 100 for detecting abnormal patterns.

FIG. 3 is a graph illustrating an example of the distribution of Mahalanobis distances from calcification points and from noise, to candidate points.

FIG. 4 is a graph that illustrates an example of size and density distributions of candidate points that exist within regions in the vicinities of candidate points.

FIG. 5 is a graph illustrating an example of the distribution of the percentages of numbers of the candidate regions within a plurality of cluster regions, with respect to the number of all of the candidate points within an image.

FIG. 6 is a schematic diagram illustrating an apparatus 200 for detecting abnormal patterns, which is an embodiment of the second apparatus for detecting abnormal patterns of the present invention.

FIG. 7 is a flow chart that illustrates the processes performed by the apparatus 200 for detecting abnormal patterns.

### DESCRIPTION OF THE PREFERRED EMBODIMENTS

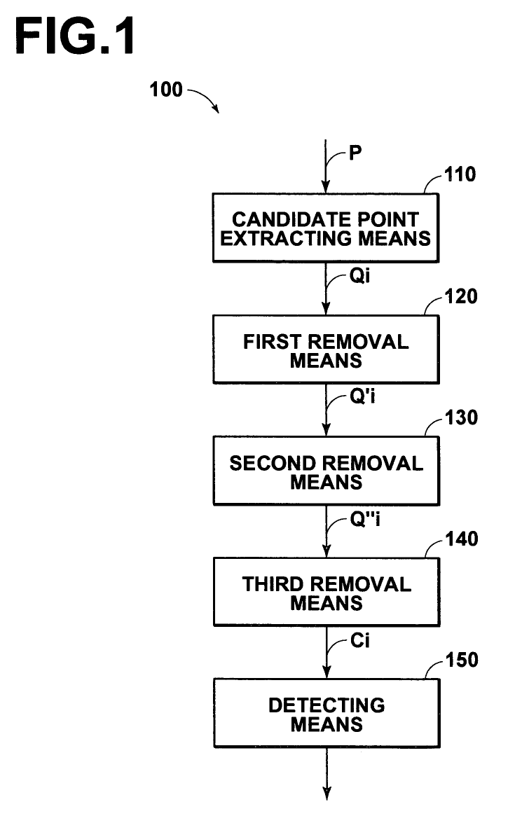

Hereinafter, embodiments of the present invention will be described with reference to the attached drawings. FIG. 1 is a schematic diagram illustrating an apparatus 100 for detecting abnormal patterns, which is an embodiment of the first apparatus for detecting abnormal patterns of the present invention.

The apparatus 100 comprises: a candidate point extracting means 110; a first removal means 120; a second removal means 130; a third removal means 140; and a detecting means 150. The candidate point extracting means 110 extracts candidate points Qi for microcalcification patterns from within an image P. The first removal means 120 judges whether the extracted candidate points Qi are calcification points, based on first characteristic amounts that focus on calcification points of a microcalcification pattern, and removes those candidate points which are judged not to be calcification points. The second removal means 130 judges whether the candidate points Q′i, which remain after judgment by the first removal means 120, are calcification points, based on second characteristic amounts that focus on regions in the vicinity of the calcification points, and removes those candidate points which are judged not to be calcification points. The third removal means 140 judges whether the candidate points Q″i, which remain after judgment by the second removal means 130, are calcification points, based on third characteristic amounts that focus on cluster regions, formed by clusters of calcification points, and removes those cluster regions which are judged not to be microcalcification patterns. The detecting means 150 detects the cluster regions Ci, which remain after the judgment by the third removal means 140, as microcalcification patterns.

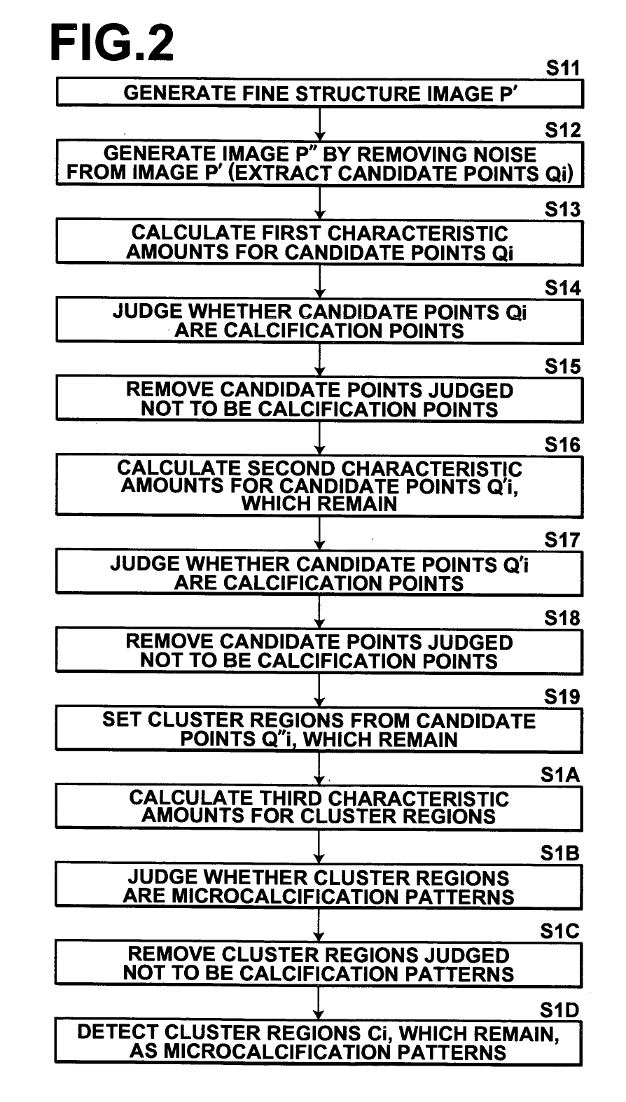

Next, the operation of the apparatus 100 having the construction described above will be described. FIG. 2 is a flow chart that illustrates the processes performed by the apparatus 100 for detecting abnormal patterns.

When an image data set P, which represents an image of a breast (mammogram), is input to the candidate point extracting means 110, the candidate point extracting means 110 administers a morphology filter process on the image data set P, and generates a fine structure image P′ (step S11). Then, a threshold value process, to roughly remove noise components, is performed with respect to the fine structure image P′. That is, pixels having density values greater than or equal to, or less than a predetermined threshold value are removed, to generate an image P″, in which candidate points for microcalcifications are extracted (step S12). Note that the image P″ includes noise components in addition to true calcification points.

When the candidate points Qi for microcalcifications are extracted into the image P″ by the candidate point extracting means 110, the first removal means 120 performs wavelet transformation on rectangular regions (for example, 47 pixels by 47 pixels), each having a candidate point Qi at its center. Then, characteristic amounts that represent the sizes, the densities, the shapes and the like of individual candidate points within the wavelet transformed images, are calculated, as first characteristic amounts that focus on calcification points themselves (step S13). Next, combinations of quasi-optimal characteristic amounts, which are selected by a sequential selection method, are employed to obtain a Mahalanobis distance D1 from a pattern class of an image of calcification points to the candidate points (hereinafter, referred to as “Mahalanobis distance from calcification points), and a Mahalanobis distance D2 from a pattern class of an image of noise components to the candidate points (hereinafter, referred to as “Mahalanobis distance from noise”). A Mahalanobis distance ratio D2/D1 is calculated, and candidate points for which the ratio D2/D1 is greater than or equal to a predetermined threshold value are judged to be calcification points (step S14), while candidate points for which the ratio D2/D1 is less than the threshold value are judged to be noise components and removed (step S15).

Here, the judgment performed by the first removal means will be described.

Here, the “Mahalanobis distances” are a measure of distance, which is employed to recognize patterns within an image. Similarities in image patterns may be discerned from the Mahalanobis distances. To perform judgment using Mahalanobis distances, first, a plurality of characteristics of image patterns are represented by vectors. The Mahalanobis distance is defined so as to reflect differences in the vectors between an image, which is the target of pattern recognition, and a reference image. Accordingly, whether the candidate points are calcification points may be judged, by discerning the similarities between the extracted candidate points and image patterns of malignant calcification points.

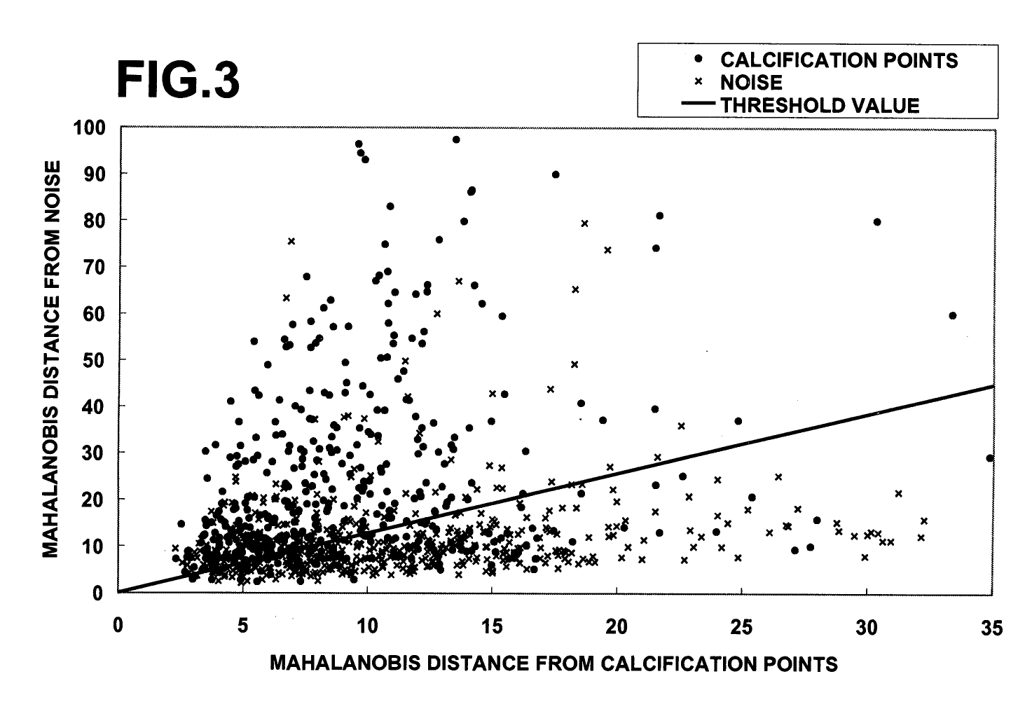

FIG. 3 is a graph illustrating an example of the distribution of Mahalanobis distances with respect to a plurality of candidate points. As is clear from FIG. 3, true calcification points have a tendency that Mahalanobis distances D1 from calcification points are small, and Mahalanobis distances D2 from noise are large. Conversely, noise components have a tendency that Mahalanobis distances D1 from calcification points are large, and Mahalanobis distances D2 from noise are small. Accordingly, the probability that candidate points are calcification points increases as the Mahalanobis distance ratio D2/D1 increases, and the probability that candidate points are noise components increases as the Mahalanobis distance ratio D2/D1 decreases. Therefore, a predetermined threshold value (0.8, for example) may be set, and candidate points may be judged to be calcification points if the Mahalanobis distance ratio D2/D1 is greater than or equal to the threshold vale, or judged to be noise components if the Mahalanobis distance ratio D2/D1 is less than the threshold value.

After the first removal means 120 removes candidate points which have been judged to be noise components, the second removal means 130 defines circular regions, each having at its center a candidate point Q′i, which remain after the removal process performed by the first removal means 120. The numbers K of other candidate points that are present within the circular regions, a variance V1 of the sizes of the candidate points, and a variance V2 of the densities of the candidate points, are calculated as second characteristic amounts that focus on the regions in the vicinity of the candidate points (step S16) Then, the numbers K of the candidate points are weighted more positively as the variance V1 of the sizes and the variance V2 of the densities increase, and weighted more negatively as the variance V1 of the sizes and the variance V2 of the densities decrease, to obtain weighted numbers K′ of the other candidate points within the circular regions. Candidate points having weighted numbers K′ of other candidates in their vicinity greater than or equal to a predetermined threshold value are judged to be calcification points (step S17), while other candidate points are judged to be noise components and removed (step S18).

Here, the judgment performed by the second removal means will be described.

Calcification points possess a characteristic that they are grouped closely together within comparatively small regions. Calcification points possess another characteristic, that variances of sizes and densities thereof are comparatively greater than those of noise components.

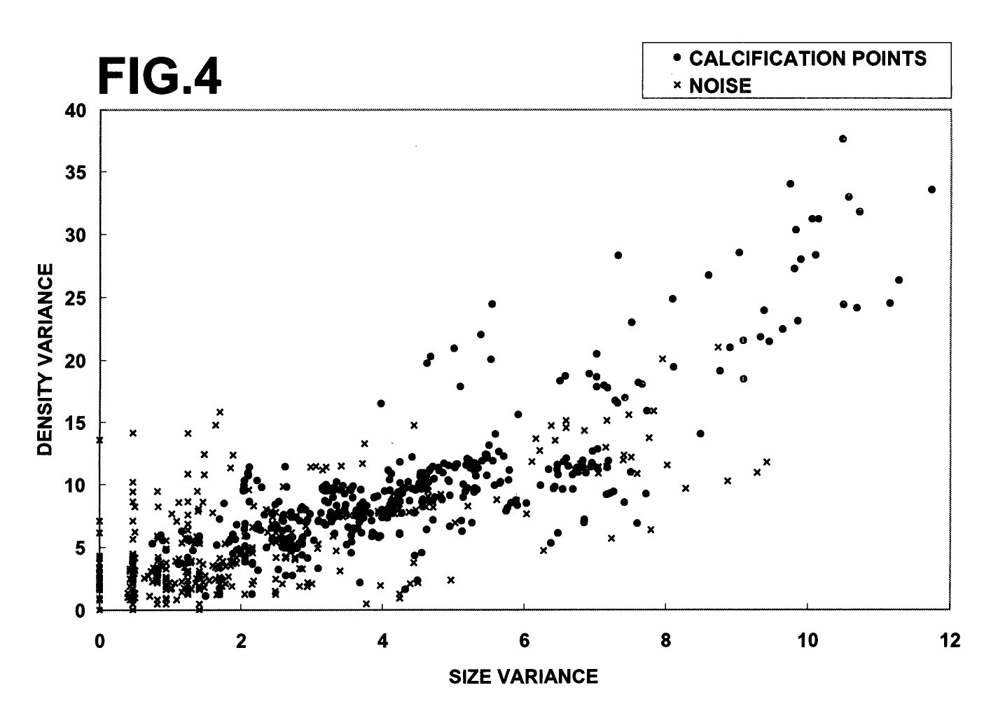

FIG. 4 is a graph that illustrates an example of size and density distributions of candidate points that exist within regions in the vicinities of a plurality of candidate points. As is clear from FIG. 4, true calcification points have a tendency that the variance in sizes and densities of candidate points in regions in their vicinities are greater than those of noise components. Accordingly, numbers of the other candidate points within a region in the vicinity of a candidate point (for example, a circular region having a radius of 57 pixels) are weighted more positively as the variance of the sizes and of the densities increase. Candidate points, having weighted numbers of other candidate points in their vicinity greater than or equal to a predetermined threshold value (for example, 5), maybe judged to be calcification points, while candidate points having weighted numbers of other candidate points in their vicinity may be judged to be noise components.

After the second removal means 130 removes candidate points which are judged to be noise components, the third removal means 140 defines cluster regions, formed of candidate points Q″i, which remain after the removal process performed by the second removal means 130 (step S19). Candidate points Q″i that have circular regions in their vicinities that overlap with each other are defined as belonging to the same cluster, therefore the circular regions are connected when forming the clusters. The numbers KK of candidate points which are present within each of the cluster regions are calculated, as third characteristic amounts that focus on the cluster regions (step S1A). In addition, the number ZK, of all of the candidate points which are present within the image P″ (excluding those which have been removed), is calculated. Percentages R of the numbers KK with respect to the number ZK are obtained, and cluster regions having percentages R greater than or equal to a predetermined threshold value are judged to be microcalcification patterns (step S1B), while other cluster regions are judged to be noise and removed (step S1C).

Note that the third characteristic amounts and the percentages R may alternatively be obtained in the following manner. The numbers KK of candidate points, which are present within each of the cluster regions, are calculated along with a variance KV1 of the sizes thereof and a variance KV2 of the densities thereof. At the same time, the number ZK, of all of the candidate points which are present within the image P″ (excluding those which have been removed), is calculated, along with a variance ZV1 of the sizes thereof and a variance ZV2 of the densities thereof. Further, the numbers KK of the candidate points are weighted more positively as the variance KV1 of the sizes and the variance KV2 of the densities increase, and weighted more negatively as the variance KV1 of the sizes and the variance KV2 of the densities decrease, to obtain weighted numbers KK′ of the candidate points within the cluster regions. At the same time, the numbers ZK, of all of the candidate points within the image P″, are weighted more positively as the variance ZV1 of the sizes and the variance ZV2 of the densities increase, and weighted more negatively as the variance XV1 of the sizes and the variance XV2 of the densities decrease, to obtain a weighted number ZK′ of the candidate points within the image P″. Thereafter, percentages R of the weighted numbers KK′, of the candidate points within the cluster regions, with respect to the weighted number ZK′, of all of the candidate points within the image P″, are obtained.

Here, the judgment performed by the third removal means will be described.

As described earlier, calcification points possess a characteristic that they are grouped closely together within comparatively small regions. Calcification points possess another characteristic, that variances of sizes and densities thereof are comparatively greater than those of noise components.

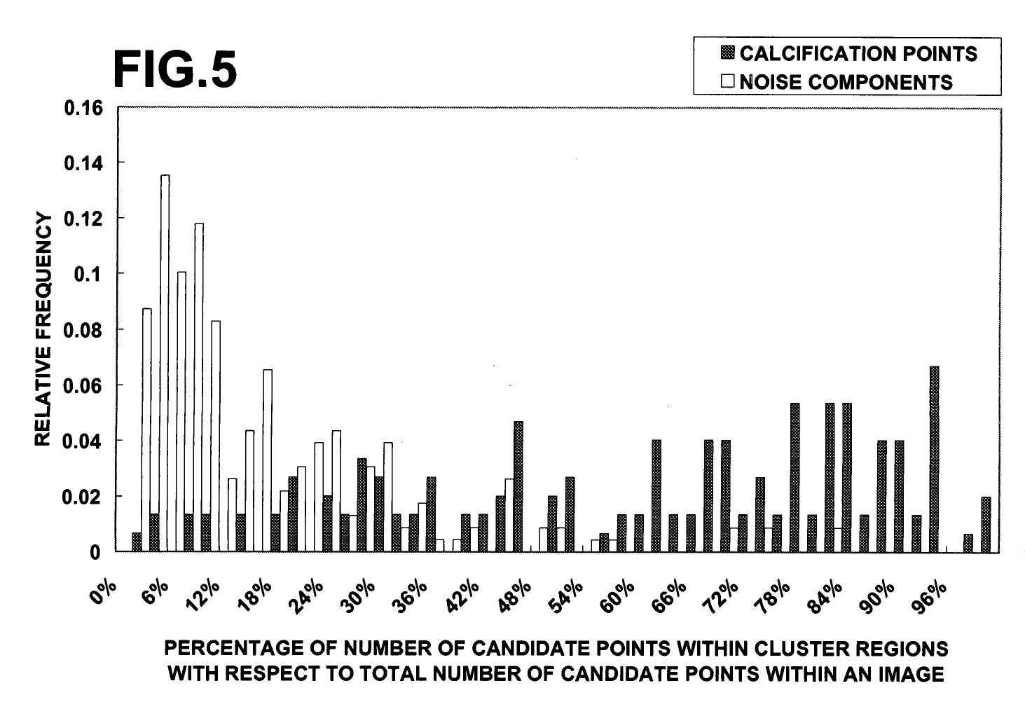

FIG. 5 is a graph illustrating an example of the distribution of the percentages of numbers of the candidate regions within a plurality of cluster regions, with respect to the number of all of the candidate points within an image. It is clear from this graph that in the case that the cluster regions are formed of true calcification points, that there is a tendency for these percentages to be high. Accordingly, clusters having numbers of candidate points therein, weighted more positively as the variances in sizes and densities of the candidate points increase, which are greater than or equal to a threshold percentage value (for example, 17%) with respect to a number of all of the candidate points within an image, weighted more positively as the variances in sizes and densities of the candidate points increase, may be judged to be clusters of calcification points, that is, true microcalcification patterns. Meanwhile, clusters having weighted numbers of candidate points therein which are less than the threshold percentage value maybe judged to be clusters of noise components.

The detecting means 150 detects cluster regions Ci, which remain after the removal process by the third removal means 140, as candidates for microcalcification patterns (step S1D).

Note that the first removal means 120 need not necessarily calculate the aforementioned Mahalanobis distances. Judgment may be performed by performing threshold value processes on each of the characteristic amounts themselves. Alternatively, judgment may be performed by taking both the characteristic amounts and the Mahalanobis distances into consideration.

Note also that the third removal means 140 may perform judgment by: calculating the fluctuations in sizes and densities of candidate points within cluster regions and the shapes of the cluster regions, and taking these values into consideration.

According to an apparatus 100 for detecting abnormal patterns such as that described above, discrimination processes are performed in an order which has been empirically proven to increase the accuracy of discrimination. First, a discrimination process is performed with respect to the extracted candidate points based on the first characteristic amounts, which focus on the calcification points of the microcalcification patterns themselves. Then, a discrimination process is performed based on the second characteristic amounts, which focus on the region in the vicinity of the calcification points. Next, a discrimination process is performed based on the third characteristic amounts, which focus on cluster regions formed of clusters of calcification points. Therefore, noise components are effectively removed, and it becomes possible to discriminate microcalcification patterns with high accuracy. Thereby, the diagnostic ability by a physician is improved.

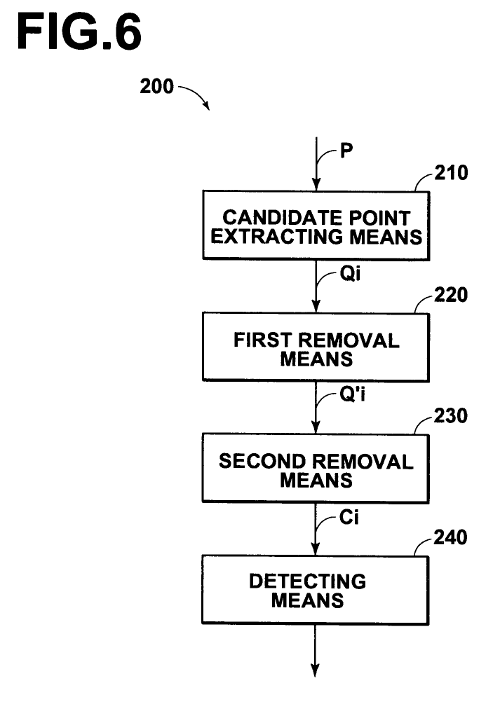

FIG. 6 is a schematic diagram illustrating an apparatus 200 for detecting abnormal patterns, which is an embodiment of the second apparatus for detecting abnormal patterns of the present invention.

The apparatus 200 for detecting abnormal patterns comprises: a candidate point extracting means 210; a first removal means 220; a second removal means 230; and a detecting means 240. The candidate point extracting means 210 extracts candidate points Qi for microcalcification patterns from within an image P. The first removal means 220 judges whether the extracted candidate points Qi are calcification points, based on first characteristic amounts that focus on calcification points of a microcalcification pattern, and based on second characteristic amounts that focus on regions in the vicinity of the calcification points, and removes those candidate points which are judged not to be calcification points. Note that the first removal means 220 is different from the first removal means 120 of the apparatus 100 for detecting abnormal patterns of the previous embodiment. The second removal means 230 judges whether the candidate points Q′i, which remain after judgment by the first removal means 220, are calcification points, based on third characteristic amounts that focus on cluster regions, formed by clusters of calcification points, and removes those cluster regions which are judged not to be microcalcification patterns. Note that the second removal means 230 is different from the second removal means 130 of the previous embodiment. The detecting means 240 detects the cluster regions Ci, which remain after the judgment by the second removal means 230, as microcalcification patterns.

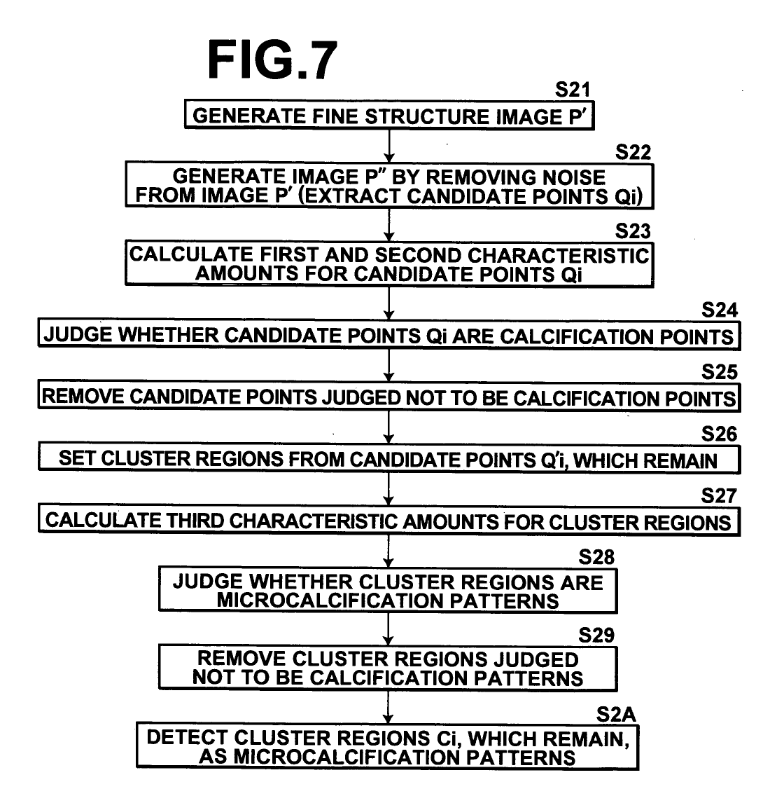

Next, the operation of the apparatus 200 having the construction described above will be described. FIG. 7 is a flow chart that illustrates the processes performed by the apparatus 200 for detecting abnormal patterns.

When an image data set P, which represents an image of a breast (mammogram), is input to the candidate point extracting means 210, the candidate point extracting means 210 administers a morphology filter process on the image data set P, and generates a fine structure image P′ (step S21). Then, a threshold value process, to roughly remove noise components, is performed with respect to the fine structure image P′. That is, pixels having density values greater than or equal to, or less than a predetermined threshold value are removed, to generate an image P″, in which candidate points for microcalcifications are extracted (step S22). Note that the image P″ includes noise components in addition to true calcification points.

When the candidate points Qi for microcalcifications are extracted into the image P″ by the candidate point extracting means 210, the first removal means 220 performs wavelet transformation on a rectangular region (for example, 47 pixels by 47 pixels) having a candidate point Qi at its center. Then, characteristic amounts that represent the sizes, the densities, the shapes and the like of individual candidate points within the wavelet transformed image, are calculated, as first characteristic amounts that focus on calcification points themselves. At the same time, the first removal means 220 defines circular regions, each having a candidate point Qi at its center. The numbers K of other candidate points that are present within the circular regions, a variance V1 of the sizes of the candidate points, and a variance V2 of the densities of the candidate points, are calculated as second characteristic amounts that focus on the regions in the vicinity of the candidate points (step S23). At this time, the numbers K of the candidate points may be weighted more positively as the variance V1 of the sizes and the variance V2 of the densities increase, and weighted more negatively as the variance V1 of the sizes and the variance V2 of the densities decrease, to obtain weighted numbers K′ of the other candidate points within the circular regions. The weighted numbers K′ may also be utilized as a first characteristic amount. Next, combinations of quasi-optimal characteristic amounts, which are selected by a sequential selection method, are employed to obtain a Mahalanobis distance D1 from calcification points, and a Mahalanobis distance D2 from noise. A Mahalanobis distance ratio D2/D1 is calculated, and candidate points for which the ratio D2/D1 is greater than or equal to a predetermined threshold value are judged to be calcification points (step S24), while candidate points for which the ratio D2/D1 is less than the threshold value are judged to be noise components and removed (step S25).

After the first removal means 220 removes candidate points which are judged to be noise components, the second removal means 230 defines cluster regions, formed of candidate points Q′i, which remain after the removal process performed by the first removal means 220 (step S26). Candidate points Q′i that have circular regions in their vicinities that overlap with each other are defined as belonging to the same cluster, therefore the circular regions are connected when forming the clusters. The numbers KK of candidate points which are present within each of the cluster regions are calculated, as third characteristic amounts that focus on the cluster regions (step S27). In addition, the number ZK, of all of the candidate points which are present within the image P′ (excluding those which have been removed), is calculated. Percentages R of the numbers KK with respect to the number ZK are obtained, and cluster regions having percentages R greater than or equal to a predetermined threshold value are judged to be microcalcification patterns (step S28), while other cluster regions are judged to be noise and removed (step S29).

Note that the third characteristic amounts and the percentages R may alternatively be obtained in the following manner. The numbers KK of candidate points, which are present within each of the cluster regions, are calculated along with a variance KV1 of the sizes thereof and a variance KV2 of the densities thereof. At the same time, the number ZK, of all of the candidate points which are present within the image P′ (excluding those which have been removed), is calculated, along with a variance ZV1 of the sizes thereof and a variance ZV2 of the densities thereof. Further, the numbers KK of the candidate points are weighted more positively as the variance KV1 of the sizes and the variance KV2 of the densities increase, and weighted more negatively as the variance KV1 of the sizes and the variance KV2 of the densities decrease, to obtain weighted numbers KK′ of the candidate points within the cluster regions. At the same time, the numbers ZK, of all of the candidate points within the image P″, are weighted more positively as the variance ZV1 of the sizes and the variance ZV2 of the densities increase, and weighted more negatively as the variance XV1 of the sizes and the variance XV2 of the densities decrease, to obtain a weighted number ZK′ of the candidate points within the image P″. Thereafter, percentages R of the weighted numbers KK′, of the candidate points within the cluster regions, with respect to the weighted number ZK′, of all of the candidate points within the image P″, are obtained.

The detecting means 240 detects cluster regions Ci, which remain after the removal process by the second removal means 230, as candidates for microcalcification patterns (step S2A)

Note that the first removal means 220 need not necessarily calculate the aforementioned Mahalanobis distances. Judgment may be performed by performing threshold value processes on each of the characteristic amounts themselves. Alternatively, judgment may be performed by taking both the characteristic amounts and the Mahalanobis distances into consideration.

Note also that the third removal means 230 may perform judgment by calculating the fluctuations in sizes and densities of candidate points within cluster regions and the shapes of the cluster regions, and taking these values into consideration.

According to the apparatus 200 for detecting abnormal patterns, the discrimination processes are performed in an order which has been empirically proven to increase the accuracy of discrimination. First, a discrimination process is performed with respect to the extracted candidate points based on the first characteristic amounts, which focus on the calcification points of the microcalcification patterns themselves, and based on the second characteristic amounts, which focus on the region in the vicinity of the calcification points. Next, a discrimination process is performed based on the third characteristic amounts, which focus on cluster regions formed of clusters of calcification points. Therefore, noise components are effectively removed, and it becomes possible to discriminate microcalcification patterns with high accuracy. Thereby, the diagnostic ability by a physician is improved.

Note that programs that cause a computer to function as each of the means of the apparatuses as described in the embodiments above may be generated. The programs may be provided recorded in computer readable media, or recorded in recording media, or in a server, from which computers may download the programs. By providing the programs and executing them on a computer, the same advantageous effects as those obtained by the apparatuses described above may be obtained.

1. A method for detecting abnormal patterns, comprising the steps of:
extracting candidate points for microcalcification patterns within an image, based on image data that represents the image;
judging whether the extracted candidate points are calcification points, based on first characteristic amounts that focus on calcification points of microcalcification patterns;
removing candidate points which are judged to not be calcifications in a first removal process;
judging whether the candidate points that remain after the first removal process are calcification points, based on second characteristic amounts that focus on the region in the vicinity of calcification points;
removing candidate points which are judged to not be calcification points in a second removal process;
judging whether the candidate points that remain after the second removal process are calcification points, based on third characteristic amounts that focus on cluster regions, formed of clusters of calcification points;
removing cluster regions which are judged not to be microcalcification patterns; and
detecting the remaining cluster regions as microcalcification patterns.

2. A method for detecting abnormal patterns, comprising the steps of:
extracting candidate points for microcalcification patterns within an image, based on image data that represents the image;
judging whether the extracted candidate points are calcification points, based on first characteristic amounts that focus on calcification points of microcalcification patterns and on second characteristic amounts that focus on the region in the vicinity of calcification points;
removing candidate points which are judged to not be calcification points;
judging whether the remaining candidate points are calcification points, based on third characteristic amounts that focus on cluster regions, formed of clusters of calcification points;
removing cluster regions which are judged not to be microcalcification patterns; and
detecting the remaining cluster regions as microcalcification patterns.

3. An apparatus for detecting abnormal patterns, comprising:
candidate point extracting means, for extracting candidate points for microcalcification patterns within an image, based on image data that represents the image;
a first removal means, for judging whether the extracted candidate points are calcification points, based on first characteristic amounts that focus on calcification points of microcalcification patterns, and removing candidate points which are judged to not be calcifications in a first removal process;
a second removal means, for judging whether the candidate points that remain after the first removal process are calcification points, based on second characteristic amounts that focus on the region in the vicinity of calcification points, and removing candidate points which are judged to not be calcification points in a second removal process;
a third removal means, for judging whether the candidate points that remain after the second removal process are calcification points, based on third characteristic amounts that focus on cluster regions, formed of clusters of calcification points, and removing cluster regions which are judged not to be microcalcification patterns in a third removal process; and
a detecting means, for detecting the cluster regions that remain after the third removal process as microcalcification patterns.

4. An apparatus for detecting abnormal patterns as defined in claim 3, wherein:
the first characteristic amounts include at least one of characteristic amounts that represent the size, the density, and the shape of the candidate points.

5. An apparatus for detecting abnormal patterns as defined in claim 3, wherein:
the second characteristic amounts include at least one of characteristic amounts that represent the fluctuation in sizes, the fluctuation in densities, the fluctuation in shapes of the candidate points, and the number of candidate points which are present within a region of a predetermined size in the vicinity of a candidate point, weighted by one of the aforementioned fluctuations.

6. An apparatus for detecting abnormal patterns as defined in claim 3, wherein:
the third characteristic amounts include at least one of:
the number of candidate points within the cluster region, weighted corresponding to at least one of the number, the fluctuation in sizes, the fluctuation in densities, and the fluctuation in shapes of the candidate points;
the percentage of the number of candidate points within the cluster region with respect to the total number of the candidate points within the image; and
the percentage of the number of candidate points within the cluster region with respect to the total number of the candidate points within the image, weighted corresponding to at least one of the aforementioned fluctuations.

7. An apparatus for detecting abnormal patterns as defined in claim 3, wherein:
the judgment made by the first removal means is based on Mahalanobis distances from calcification patterns, which are calculated by the first characteristic amounts, and from noise components.

8. An apparatus for detecting abnormal patterns as defined in claim 7, wherein:
the first characteristic amounts include at least one of characteristic amounts that represent the size, the density, and the shape of the candidate points.

9. An apparatus for detecting abnormal patterns as defined in claim 8, wherein:
the second characteristic amounts include at least one of characteristic amounts that represent the fluctuation in sizes, the fluctuation in densities, the fluctuation in shapes of the candidate points, and the number of candidate points which are present within a region of a predetermined size in the vicinity of a candidate point, weighted by one of the aforementioned fluctuations.

10. An apparatus for detecting abnormal patterns as defined in claim 9, wherein:
the third characteristic amounts include at least one of:
the number of candidate points within the cluster region, weighted corresponding to at least one of the number, the fluctuation in sizes, the fluctuation in densities, and the fluctuation in shapes of the candidate points;
the percentage of the number of candidate points within the cluster region with respect to the total number of the candidate points within the image; and
the percentage of the number of candidate points within the cluster region with respect to the total number of the candidate points within the image, weighted corresponding to at least one of the aforementioned fluctuations.

11. An apparatus for detecting abnormal patterns, comprising:
a candidate point extracting means, for extracting candidate points for microcalcification patterns within an image, based on image data that represents the image;
a first removal means, for judging whether the extracted candidate points are calcification points, based on first characteristic amounts that focus on calcification points of microcalcification patterns and on second characteristic amounts that focus on the region in the vicinity of calcification points, and removing candidate points which are judged to not be calcification points in a first removal process;
a second removal means, for judging whether the candidate points that remain after the first removal process are calcification points, based on third characteristic amounts that focus on cluster regions, formed of clusters of calcification points, and removing cluster regions which are judged not to be microcalcification patterns in a second removal process; and
detecting means, for detecting the cluster regions that remain after the second removal process as microcalcification patterns.

12. An apparatus for detecting abnormal patterns as defined in claim 11, wherein:
the first characteristic amounts include at least one of characteristic amounts that represent the size, the density, and the shape of the candidate points.

13. An apparatus for detecting abnormal patterns as defined in claim 11, wherein:
the second characteristic amounts include at least one of characteristic amounts that represent the fluctuation in sizes, the fluctuation in densities, the fluctuation in shapes of the candidate points, and the number of candidate points which are present within a region of a predetermined size in the vicinity of a candidate point, weighted by one of the aforementioned fluctuations.

14. An apparatus for detecting abnormal patterns as defined in claim 11, wherein:
the third characteristic amounts include at least one of:
the number of candidate points within the cluster region, weighted corresponding to at least one of the number, the fluctuation in sizes, the fluctuation in densities, and the fluctuation in shapes of the candidate points;
the percentage of the number of candidate points within the cluster region with respect to the total number of the candidate points within the image; and
the percentage of the number of candidate points within the cluster region with respect to the total number of the candidate points within the image, weighted corresponding to at least one of the aforementioned fluctuations.

15. An apparatus for detecting abnormal patterns as defined in claim 11, wherein:
the judgment made by the first removal means is based on Mahalanobis distances from calcification patterns, which are calculated by the first characteristic amounts, and from noise components.

16. An apparatus for detecting abnormal patterns as defined in claim 15, wherein:
the first characteristic amounts include at least one of characteristic amounts that represent the size, the density, and the shape of the candidate points.

17. An apparatus for detecting abnormal patterns as defined in claim 16, wherein:
the second characteristic amounts include at least one of characteristic amounts that represent the fluctuation in sizes, the fluctuation in densities, the fluctuation in shapes of the candidate points, and the number of candidate points which are present within a region of a predetermined size in the vicinity of a candidate point, weighted by one of the aforementioned fluctuations.

18. An apparatus for detecting abnormal patterns as defined in claim 17, wherein:
the third characteristic amounts include at least one of:
the number of candidate points within the cluster region, weighted corresponding to at least one of the number, the fluctuation in sizes, the fluctuation in densities, and the fluctuation in shapes of the candidate points;
the percentage of the number of candidate points within the cluster region with respect to the total number of the candidate points within the image; and
the percentage of the number of candidate points within the cluster region with respect to the total number of the candidate points within the image, weighted corresponding to at least one of the aforementioned fluctuations.

19. A program that causes a computer to execute a method for detecting abnormal patterns, comprising the procedures of:
extracting candidate points for microcalcification patterns within an image, based on image data that represents the image;
judging whether the extracted candidate points are calcification points, based on first characteristic amounts that focus on calcification points of microcalcification patterns;
removing candidate points which are judged to not be calcifications in a first removal process;
judging whether the candidate points that remain after the first removal process are calcification points, based on second characteristic amounts that focus on the region in the vicinity of calcification points;
removing candidate points which are judged to not be calcification points in a second removal process;
judging whether the candidate points that remain after the second removal process are calcification points, based on third characteristic amounts that focus on cluster regions, formed of clusters of calcification points;
removing cluster regions which are judged not to be microcalcification patterns; and
detecting the remaining cluster regions as microcalcification patterns.

20. A program that causes a computer to execute a method for detecting abnormal patterns, comprising the procedures of:
extracting candidate points for microcalcification patterns within an image, based on image data that represents the image;
judging whether the extracted candidate points are calcification points, based on first characteristic amounts that focus on calcification points of microcalcification patterns and on second characteristic amounts that focus on the region in the vicinity of calcification points;
removing candidate points which are judged to not be calcification points;
judging whether the remaining candidate points are calcification points, based on third characteristic amounts that focus on cluster regions, formed of clusters of calcification points;
removing cluster regions which are judged not to be microcalcification patterns; and
detecting the remaining cluster regions as microcalcification patterns.

21. A computer readable recording medium having stored therein a program that causes a computer to execute a method for detecting abnormal patterns, comprising the procedures of:
extracting candidate points for microcalcification patterns within an image, based on image data that represents the image;
judging whether the extracted candidate points are calcification points, based on first characteristic amounts that focus on calcification points of microcalcification patterns;
removing candidate points which are judged to not be calcifications in a first removal process;
judging whether the candidate points that remain after the first removal process are calcification points, based on second characteristic amounts that focus on the region in the vicinity of calcification points;
removing candidate points which are judged to not be calcification points in a second removal process;
judging whether the candidate points that remain after the second removal process are calcification points, based on third characteristic amounts that focus on cluster regions, formed of clusters of calcification points;
removing cluster regions which are judged not to be microcalcification patterns; and
detecting the remaining cluster regions as microcalcification patterns.

22. A computer readable recording medium having stored therein a program that causes a computer to execute a method for detecting abnormal patterns, comprising the procedures of:
extracting candidate points for microcalcification patterns within an image, based on image data that represents the image;
judging whether the extracted candidate points are calcification points, based on first characteristic amounts that focus on calcification points of microcalcification patterns and on second characteristic amounts that focus on the region in the vicinity of calcification points;
removing candidate points which are judged to not be calcification points;
judging whether the remaining candidate points are calcification points, based on third characteristic amounts that focus on cluster regions, formed of clusters of calcification points;
removing cluster regions which are judged not to be microcalcification patterns; and
detecting the remaining cluster regions as microcalcification patterns.
